(19) United States
(12) Patent Application Publication
(10) Pub. No.: US 2015/0082098 A1
(43) Pub. Date: Mar. 19, 2015

(54) FORECASTING IN COMPUTING ENVIRONMENTS

(71) Applicant: International Business Machines Corporation, Armonk, NY (US)

(72) Inventor: Vishal Anand, Katihar (IN)

(73) Assignee: International Business Machines Corporation, Armonk, NY (US)

(21) Appl. No.: 14/028,693

(22) Filed: Sep. 17, 2013

(51) Int. Cl. G06F 11/30

(52) U.S. Cl. CPC G06F 11/3055
USPC 714/47.1

(57) ABSTRACT

A method, system and a computer program product for forecasting in computing environments includes capturing an architectural pattern in a first computing environment, detecting a state in the captured architectural pattern, identifying an architectural pattern identical to the captured architectural pattern in one or more other computing environments and forecasting the detected state in the one or more other computing environments.

### TECHNICAL FIELD

The present invention generally relates to forecasting in computing environments and more specifically towards forecasting undesirable states in computing environments.

### BACKGROUND OF THE INVENTION

Large scale computing environment, such as the one deployed in businesses generally referred to as enterprise computing systems, are complex and demand a great deal of planning and resources in designing, creating and upkeep thereof. Such computing environment comprises a large number of inter connected hardware and software. Critical business functions are dependent on such computing environments and no business can afford down time of any element of a computing environment running critical business functions even for a shortest period of time. Even a small state of error in any element of the computing environment if not diagnosed and rectified in time can snowball into a huge issue and can bring the entire computing environment to a halt and it can then be dysfunctional.

To avoid disruptions in functions dependent on such computing environments, each element of the computing environment is generally monitored on real time basis through various monitoring systems available in the market. As soon as an error is diagnosed, which has affected the functioning of an element in the computing environment, immediate rectification measures are deployed so that the downtime of the affected element is as less as possible.

However, sophisticated the computing environments and elements thereof may be, it is simply not possible to achieve a 100% uptime thereof. There is always a possibility of a sudden downtime, however short it may be. Even a short duration down time of computing environment may prove costly. Since various elements of the computing elements are interconnected and the functions dependent on each other, an issue in one computing element may bring the entire computing environment to a halt or worse may affect other elements of the computing environment. This may expand the down time since each element of the computing environment is required to be diagnosed and rectified. Sometimes, it is not possible to reduce the down time even by attending to all affected elements of the computing environment at a time with a large number of technicians. It is possible that diagnosing a problem in one element of the computing environment may not be possible while another element connected therewith is not fully functional. Thus there is a need of predicting or forecasting errors or issues in computing environment which can be anticipated before allowing the errors or issues to disrupt the functions supported by it or bringing the entire computing environment down.

Generally, businesses deploy similar or near similar computing environments or having common elements therein across geographies or various functions of the business. For example, a Bank may deploy similar or with little variations computing environments in different countries for running their banking operations. Technically, these computing environments may be independent of each other. Because the computing environments perform more or less the same function, there may be a good degree of similarity in them. Thus, it is most likely that if there is a downtime in one computing environment, say due to element A which is also common to another computing environment, the another computing environment may also suffer from such downtime in near or short term future. For example, the down time in a computing environment may have been caused by application software which crashed because of a manner in which a user accessed it. Another computing environment has which has also the same element is thus most likely to suffer the same fate if used in the same manner in future. There is a need to address this problem.

### SUMMARY

A method, system and a computer program product for forecasting in computing environments is provided. An architectural pattern in a first computing environment is captured and monitored. As soon as a state is detected in the captured architectural pattern, an architectural pattern identical to the captured architectural pattern in one or more other computing environments is identified and the detected state is forecasted in the one or more other computing environments.

According to embodiments, the captured architectural pattern includes one or more elements from the group consisting of an Operating System, Server system, Storage System, Database System, Middleware System, Network Systems and various Applications. The first and the one or more other computer computing environments are an enterprise computing environment and no computing environment has two or more identical architectural patterns.

According to embodiments, monitoring includes monitoring one or more elements of the architectural pattern. Detection includes detecting an error state in the one or more elements of the captured architectural pattern wherein if the error state exceeds a pre-defined threshold, the architectural pattern of which the one or more elements is a member is classified as being an undesirable state. Further, detection also includes determining a first quotient of each element of the captured architectural pattern, determining a second quotient of the captured architectural pattern and classifying the captured architectural pattern as a desirable or undesirable state based on the determined second quotient.

### BRIEF DESCRIPTION OF THE DRAWINGS

FIG. 1 illustrates a block diagram of a computing system for implementing embodiments of the present invention.

FIG. 2 illustrates a functional block diagram of a system for implementing embodiments of the present invention.

FIG. 3 illustrates a flowchart depicting steps to be performed for implementing an embodiment of the present invention.

FIG. 4 illustrates a flowchart depicting steps to be performed for implementing another embodiment of the present invention.

FIG. 5 illustrates a flowchart depicting steps to be performed for detecting an undesirable state in a captured architectural pattern in accordance with another embodiment of the present invention.

### DETAILED DESCRIPTION

As will be appreciated by one skilled in the art, embodiments of the present invention may be embodied as a system, method or computer program product. Accordingly, embodiments of the present invention may take the form of an entirely hardware embodiment, an entirely software embodiment (including firmware, resident software, micro-code, etc.) or an embodiment combining software and hardware embodiments that may all generally be referred to herein as a “circuit,” “module” or “system.” Furthermore, embodiments of the present invention may take the form of a computer program product, embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM),an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

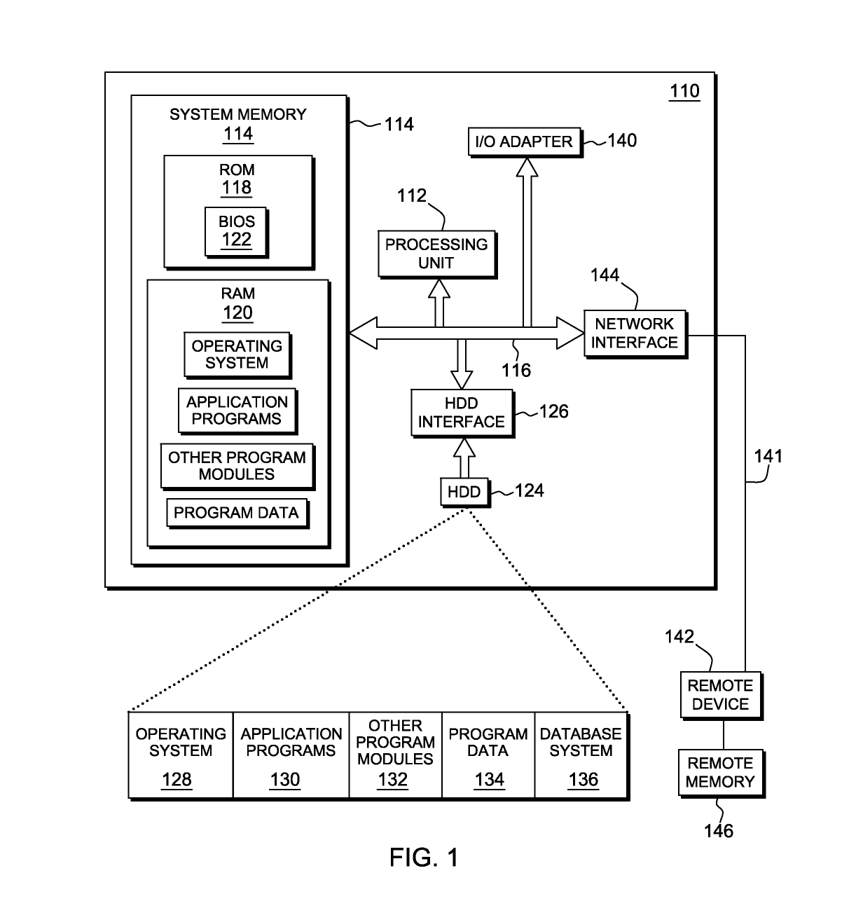

FIG. 1 illustrates a block diagram of a computing system for implementing an embodiment of the present invention. The computing system includes a computing device 110, which in turn includes a processing unit 112, a system memory 114, and a system bus 116 that couples various system components including the system memory 114 to the processing unit 112. The system bus 116 may be any of several types of bus architectures, including a memory bus, a memory controller, a peripheral bus, and a local bus using any of a variety of bus architectures, such as PCI. The system memory 114 includes a Read Only Memory (ROM) 118 and a Random Access Memory (RAM) 120. A Basic Input/Output System (BIOS) 122, containing the basic routines that help to transfer information between elements within the computing device 110, such as during start-up, is stored in the ROM 118. The computing device 110 further includes a Hard Disk Drive (HDD) 124 as computer-readable storage media. The HDD 124 is connected to the system bus 116 by an HDD interface 126. The HDD 124 provides a non-volatile storage for computer-readable instructions, data structures, program modules, and other data for the computing device 110. Although the exemplary environment described herein employs the HDD 124, it should be appreciated by those skilled in the art that other types of computer-readable storage media, which can store data that is accessible by computer, such as RAM, ROM, removable magnetic disks, removable optical disks, and the like may also be used in the exemplary operating environment.

A number of program modules may be stored on the HDD 124, including an operating system 128, one or more application programs 130, other program modules 132, program data 134, and a database system 136. The operating system 128, the one or more application programs 130, the other program modules 132 and program data 134 may be loaded onto the system memory 114 and specifically onto the RAM 120 during the functioning of the computing device 110. A user may provide commands and information through input devices, such as a keyboard, and receive output through peripheral output devices, such as monitor, speaker, printer, etc. These input and output devices are often connected to the processing unit 112 through an I/O adapter 140 coupled to the system bus 116.

In a networked environment, the computing device 110 may be connected to a remote computing device 142 through a network interface card 144. It will be appreciated that the network connections shown are exemplary, and any conventional means 141 of establishing communications links between the computers, such as a local area network, wide are network or wireless connection, may be used. In a networked environment, program modules depicted relative to the computing device 110, or its components, may be stored in a remote memory 146. The remote computing device 142 may be a personal computer, a router, a server, a network PC, a peer device, or other common network device.

Those of the ordinary skill in the art will appreciate that the hardware in FIG. 1 is a basic computing system and may vary. The architecture of the aforementioned computing device is not limiting and is only depicted as an example on which an embodiment of the present invention may be implemented. Other types of computing system such as a smart phone or a web-kiosk are well within the intended scope on which an embodiment of the present invention may be implemented.

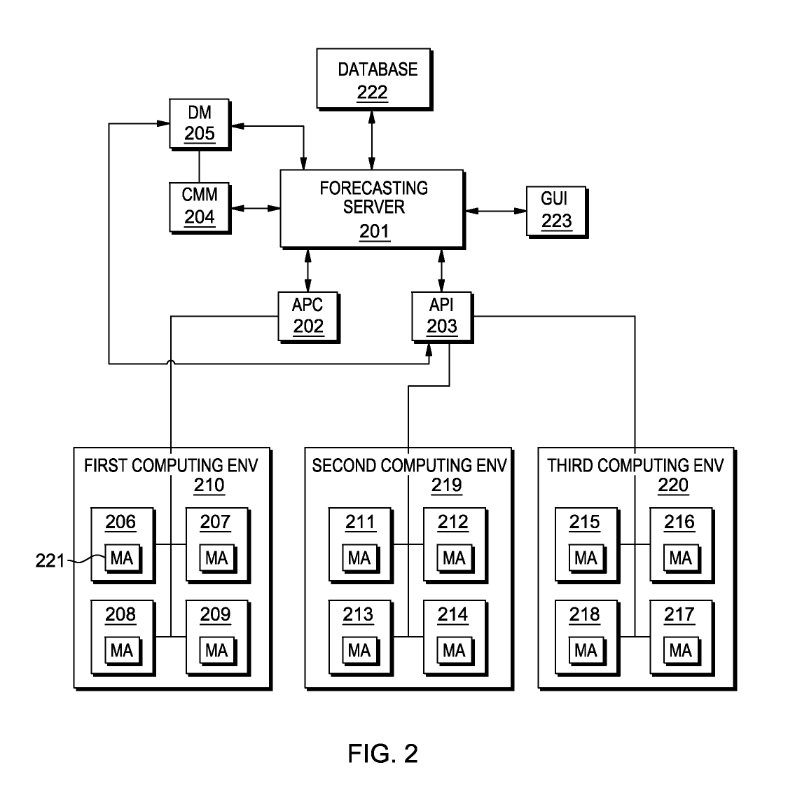

FIG. 2 illustrates a functional block diagram of a system for implementing an embodiment of the present invention. A forecasting server 201 is operably connected to an Architectural Pattern Capturers (APC) 202, Architectural Pattern Identifier (API) 203, Central Monitoring Module (CMM) 204 and a Detection Module (DM) 205. The APC 202 is operably connected to elements 206, 207, 208, 209 of a first computing environment 210 and the API 203 is operably connected to elements 211, 212, 218 of the second 219 and third 220 computing environments respectively. The second 219 and third 220 computing environments are referred to in general as the other computing environments. The number of other computing environments is not limited to the second and third computing environments and there may be as such only one or more than one other computing environments.

A computing environment is defined herein as a collection of computing elements such as computing hardware, software, and networks that support the processing and exchange of electronic information meant to support various types of computing solutions. According to an embodiment, the first 210, second 219 and third 220 computing environments are an enterprise computing environment such as a Banking enterprise computing environment. Various types of computing environments such as personal computing environment, distributed computing environment, cloud computing environment, advanced computing environments, etc are intended to be within the scope of a computing environment. Typical elements 206 . . . 209, 211 . . . 218 of the first 210, second 219 and third 220 computing environments include Operating Systems, Server systems, Client Systems, Storage Systems, Database Systems, Middleware Systems, Network Systems and Applications. The above list of elements is for illustration purpose only and may not be construed to be limiting.

The forecasting server 201, APC 202, API 203, CMM 204 and DM 205 each, according to an embodiment, is an individual computing system as illustrated in FIG. 1 configured to perform pre-designated functions through respective underlying combinations of one or more specific software and hardware. The computing systems of the forecasting server 201, APC 202, API 203, CMM 204 and DM 205 are configured to communicate with each other through a network. Alternatively, the forecasting server 201, APC 202, API 203, CMM 204 and DM 205 may be one computing system clubbed together with respective underlying combinations of specific software and hardware configured to perform pre-designated functions such as described below.

As shown in FIG. 2, the forecasting server 201 is central to the forecasting system of computing environments 210, 219, 220. The forecasting server 201 communicates with the APC 202, API 203, CMM 204 and DM 205. The APC 202, according to an embodiment, may be a computing system as illustrated in FIG. 1 with underlying software such as Tivoli, or the like, configured to capture an architectural pattern in the first computing environment 210 upon receiving an instruction from the forecasting server 201 operated by a user. The captured architectural pattern is subsequently transmitted back to the forecasting server 201 by the APC 202. Capturing the architectural pattern in the first computing environment 201 means to select one or more elements 206 . . . 209 of the first computing environment 210 to view the captured elements holistically as one computing environment or computing system. According to different embodiments, the captured architectural patterns may comprise all the elements or only those elements which are critical to the functioning of the first computing environment 210 failure of which will lead to losses to the function, such as business, it supports. The capturing of an architectural pattern may also be to capture elements of a computing environment located in a pre-designated geography or a combination of geographies. The capturing of an architectural pattern may also be to capture elements of a computing environment which are managed by a particular team. Thus there may be different reasons to view a combination of elements (captured as architectural pattern) of the first computing environment 210 as a unique computing environment or computing system. It will be apparent to a person skilled in the art that after capturing the architectural pattern in the first computing environment 210, it may be possible to edit the captured architectural pattern to exclude or include one or more elements of the first computing environment 210 and subsequently designate the edited captured architectural pattern as the captured architectural pattern in effect. All such permutations and combinations are well within the intended scope of performance of the invention.

The API 203, according to an embodiment, may be a computing system as illustrated in FIG. 1 with underlying software such as Tivoli or the like configured to identify an architectural pattern from one or more other computing environments (such as the second 219 and third 220 computing environments) which are identical to the captured architectural pattern in the first computing environment 210 upon receiving an instruction from the forecasting server 201 or from the DM 205. Identifying an architectural pattern identical to the captured architectural pattern is intended to mean that the API 203 searches architectural patterns which have the same or substantially the same elements as that in the captured architectural pattern.

According to an embodiment, each element 206 . . . 209, 211 . . . 218 of the first 210, second 219 and third 220 computing environments comprises a monitoring agent 221 which may constantly monitor each respective element and transmits the monitoring report to the CMM 204. The monitoring agent of an element is typically a software application deployed therein, configured to monitor various operational parameters of the software and or hardware components of the element. The CMM 204, according to an embodiment, is a software application for controlling the monitoring agents 221 deployed in the computing system of FIG. 1. The software applications of the monitoring agents 221 and CMM 204 are typical software applications known to a person skilled in the art. The CMM 204 controls the monitoring agents 221 of each element 206 . . . 209, 211 . . . 218 and receives monitoring reports therefrom. The forecasting server 201 after receiving the captured architectural pattern seeks and receives the monitoring reports of each element of the captured architectural pattern from the CMM 204.

The monitoring reports from the CMM 204 are then transmitted to the DM 205 by the forecasting server 201. According to another embodiment, the forecasting server 201 may instruct the CMM 204 to directly transmit the monitoring reports of the elements of the captured architectural pattern to the DM 205. The DM 205 is programmed to detect an undesirable state in the captured architectural pattern, if any, based on the received monitoring reports. As described above, the DM 205 may be a computing system as described in FIG. 1 with an underlying specific software application. The software application of the DM 205 may use one of generally available detection algorithms known to a person skilled in the art. There may be used different methods (through the underlying detection algorithm) for detecting the undesirable state in the captured architectural pattern.

For example, according to an embodiment, the undesirable state in the captured architectural pattern may be detected by first detecting an error state in one or more elements of the captured architectural pattern. The error state in an element of the captured architectural pattern may be detected by analyzing its monitoring report transmitted by the forecasting server 201 or the CMM 204 to the DM 205. The analysis may be performed by one of various available analyzing methods and its underlying algorithms known to a person skilled in the art, say for example, by comparing the state of each operational parameter of the element in the monitoring report to a reference state. If the state of the operational parameter of the element in the monitoring report is not the same or substantially the same as the reference state, the element may be classified as being in error state and if the error state of the element is beyond a pre-defined threshold, the captured architectural pattern of which the element is a member is classified as being in an undesirable state.

According to another embodiment, the undesirable state in the captured architectural pattern may be detected by determining a first quotient of each element of the captured architectural pattern, a second quotient of the captured architectural pattern and subsequently classifying the captured architectural pattern being in an undesirable state based on the second quotient. The first and second quotients are determined by the CMM 204. The first quotient may be determined by the CMM 204 by analyzing the monitoring report of the element. For example, the state of all or pre-determined operating parameters of the element in the monitoring report may be compared to a reference parameter and depending on the deviation of the state of the operating parameter in the monitoring report from the reference parameter, a pre-defined score may be assigned against each operating parameter. To determine the first quotient, the score of each operating parameter of the element in the monitoring report may be simply be summed up or aggregated or applied some pre-determined mathematical formula. The second quotient may be determined based on the first quotients of each element of the captured architectural pattern, for example, by summing up or aggregating the first quotients or applying some pre-determined mathematical formula. If the determined second quotient is beyond a predefined threshold, the captured architectural pattern may be classified as being in an undesirable state.

The aforementioned methods of detecting the undesirable state of the captured architectural pattern is not to be construed as limiting and there may be possible other methods of detecting the undesirable state of the captured architectural pattern.

Each monitoring agent 221, along with transmitting the monitoring report may also be configured to transmit technical data regarding the state of each element to enable a system administrator (of the forecasting server) to identify the problem and take corrective measures.

There is also provided a database 222 operably connected to the forecasting server 201 for storing the captured architectural patterns therein of various computing environments. The database 222 is implemented in a computing system as illustrated in FIG. 1 with appropriate underlying softwares therein well known to the persons skilled in the art. According to embodiments, the database 222 may not be a separate entity as illustrated in FIG. 2 but a part of the forecasting server.

According to an embodiment, the user, for the purpose of setting up and executing a forecasting system, logs into the forecasting server 201 through a graphical user interface (GUI) 223 operably connected to the forecasting server 201. The GUI 223, for the purpose of illustration, is shown as a separate entity in FIG. 2. However, this is not construed to be limiting and the GUI 223 may be an inherent element of the forecasting server 201. The GUI 223 is accessible by the user from a web page through a network connection such as an internet connection. The user through the forecasting server 201 executes commands to the APC 202 to capture a desired architectural pattern from the first computing environment 210. The first computing environment 210 may be a subset or part of a large computing environment or a combination of two or more computing environments considered as one for the purpose of performing an embodiment of the invention. According to a preferred embodiment, the first computing environment 210 is an enterprise computing environment comprising elements such as Operating Systems, Server systems, Client Systems, Storage Systems, Database Systems, Middleware Systems, Network Systems and various Applications. There may be other types of elements over and above the ones not mentioned here. Likewise, the first computing environment may also not comprise all the aforementioned elements. The above list of elements is for illustration purpose only and may not be construed to limiting.

As described above, the architectural pattern is captured to view all the elements captured therein as one system. According to different embodiments, the captured architectural patterns may comprise all the elements or only those elements which are necessary to the functioning of the computing environment failure of which will lead to losses to the function, such as business, it supports. The capturing of an architectural pattern may also be to capture elements of a computing environment located in a pre-designated geography or a combination of geographies. The capturing of an architectural pattern may also be to capture elements of a computing environment which are managed by a particular team. Thus there may be different reasons to view a combination of elements of a computing environment (captured as architectural pattern) as one system.

Subsequently, the forecasting server 201 triggers, through the CMM 204, may constantly monitor each element of the captured architectural pattern by the monitoring agent 221. As described above, monitoring reports from the monitoring agents 221 are received by the forecasting server 201 through the CMM 204 or transmitted to the DM 205 by the CMM 204 upon instructions from the forecasting server 201. The frequency of such transmissions may be set by the user. As soon as DM 205 detects an undesirable state, as described above, in the captured architectural pattern, transmits this information to the forecasting server 201 or the API 203 to identify an architectural pattern identical or substantially identical to the captured architectural pattern in the second 219 and third 220 computing environments. If such an identical pattern is identified in the second 219 or third 220 or both computing environments, forecasting server 201 is notified which in turn alerts the System Administrators of the respective computing environments in which the identical architectural pattern similar to the captured architectural pattern was identified.

According to a another embodiment, after capturing the architectural pattern of the first computing environment 210 by the APC 202, the API 203 immediately identifies an architectural pattern identical or substantially identical to the captured architectural pattern in the second 219 or third 220 or both computing environments without waiting for an undesirable state to be detected by the DM 205. The identified identical architectural patterns are stored in the database 222. Later, as soon as the captured architectural pattern is detected to be in an undesirable state, the forecasting server 201 forecasts the identified architectural patterns to be in undesirable state and accordingly the system administrators of the computing environments to which the identified architectural patterns belong are notified of the same.

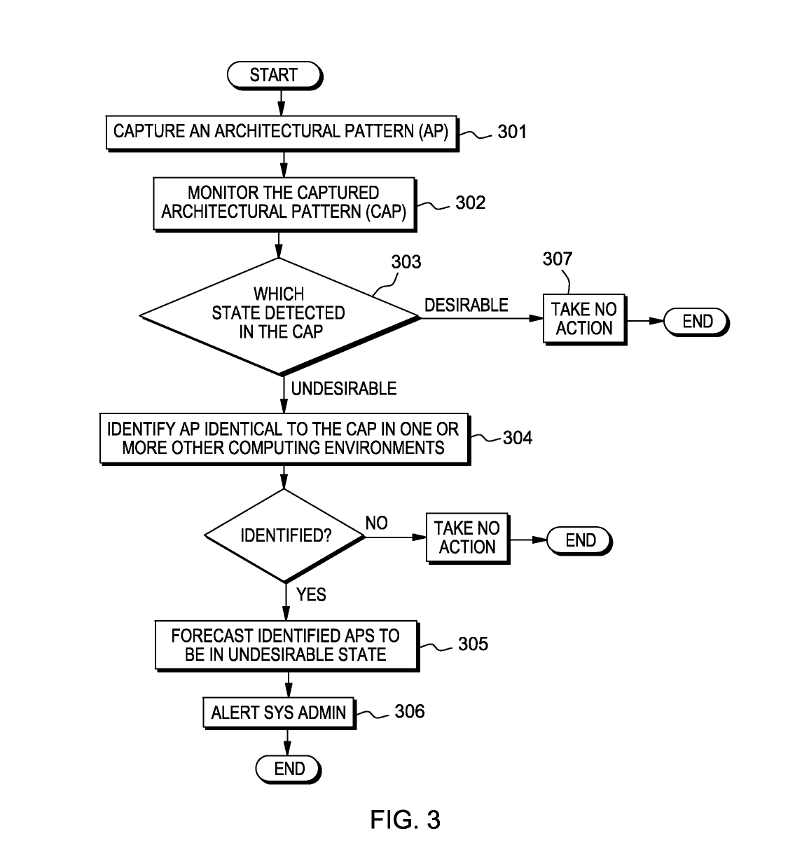

FIG. 3 illustrates flowcharts depicting steps to be performed for implementing another embodiment of the present invention. At step 301, an architectural pattern is captured from a first computing environment. A computing environment is typically defined as a collection of computing elements such as computing hardware, software, and networks that support the processing and exchange of electronic information meant to support various types of computing solutions. Various types of computing environments such as personal computing environment, distributed computing environment, cloud computing environment, advanced computing environments, etc are intended to be within the scope of a computing environment. Typical elements of a computing environment include Operating Systems, Server systems, Client Systems, Storage Systems, Database Systems, Middleware Systems, Network Systems and Applications. The above list of elements is for illustration purpose only and may not be construed to be limiting The first computing environment may be a subset or part of a large computing environment or a combination of two or more computing environments considered as one for the purpose of performing an embodiment of the invention.

The architectural pattern may be captured through software available in the market such as Tivoli or the like. It will be apparent to a person skilled in the art that the capturing of an architectural pattern may be pre-configured to exclude desired elements of the computing environment to comprise all or some of the elements in the architectural pattern. Similarly, after the capturing of the architectural pattern, it may be edited to exclude desired elements and designate the edited captured architectural pattern as the captured architectural pattern in effect. All such permutations and combinations are well within the intended scope of the performance of the invention.

The architectural pattern is captured to view all the elements captured therein holistically as one system. According to different embodiments, the captured architectural patterns may comprise all the elements or only those elements which are necessary to the functioning of the computing environment failure of which will lead to losses in function, such as business, it supports. The capturing of an architectural pattern may also be to capture elements of a computing environment located in a pre-designated geography or a combination of geographies. The capturing of an architectural pattern may also be to capture elements of a computing environment which are managed by a particular team. Thus there may be different reasons to view a combination of elements of a computing environment (captured as architectural pattern) as one system.

At step 302, the captured architectural pattern is monitored. According to an embodiment, monitoring the captured architectural pattern includes monitoring one or more elements of the captured architectural pattern. Monitoring an element of the captured architectural pattern includes monitoring one or more operational parameters of the element. Such monitoring is usually performed by software applications residing within the software or hardware element. Such types of monitoring software applications are generally known to a person skilled in the art. According to a preferred embodiment, monitoring reports are generated by such software applications.

At step 303, it is determined which state is detected in the captured architectural pattern based on the monitoring of the captured architectural pattern. At step 304, if an undesirable state is detected in the captured architectural pattern, an architectural pattern identical or substantially similar to the captured architectural pattern in one or more other computing environments is identified. At step 305, if one or more architectural patterns identical to the captured architectural pattern are identified, an undesirable state is forecasted therein. At step 306, System Administrators of the computing environment to which the identified architectural patterns belong are alerted, preferably with the monitoring report of each element to take relevant preventive action. At step 307, if a desirable state is detected in the captured architectural pattern, according to a preferred embodiment, no action is taken. At step 308, if no action is taken if there are no architectural patterns identified which are identical to the captured architectural pattern.

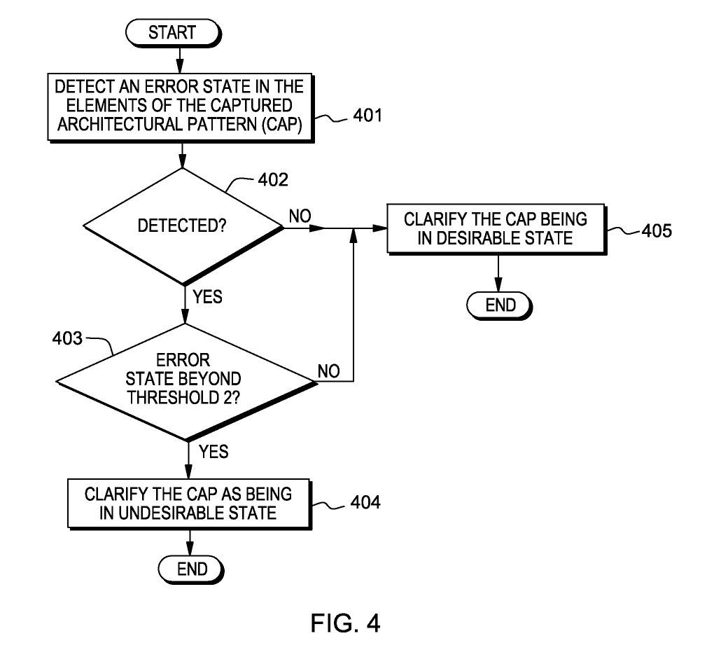

The detection of the captured architectural pattern in the undesirable state may be performed by various methods known to a person skilled in the art implemented through an underlying software application. For example, as shown in the flowchart of FIG. 4, the undesirable state in the captured architectural pattern may be detected by first detecting an error state in one or more elements of the captured architectural pattern at step 401. The error state in an element of the captured architectural pattern may be detected by analyzing the monitoring report of each element of the captured architectural pattern, say for example, by comparing state of each operational parameter of the element in the monitoring report to a reference state. If the state of the operational parameter of the element in the monitoring report is not the same or substantially the same as the reference state, the element may be classified as being in error state. At step 402, it is determined if an error state is detected in the elements of captured architectural pattern, if no error state is detected, the captured architectural pattern is classified as being in a desirable state (step 405) and no further action is taken. At step 403, it is determined if the detected error state of the element is beyond a pre-defined threshold and if yes, at step 404, the captured architectural pattern of which the element is a member is classified as being in an undesirable state. At step 405, the captured architectural pattern is classified as being in a desirable state.

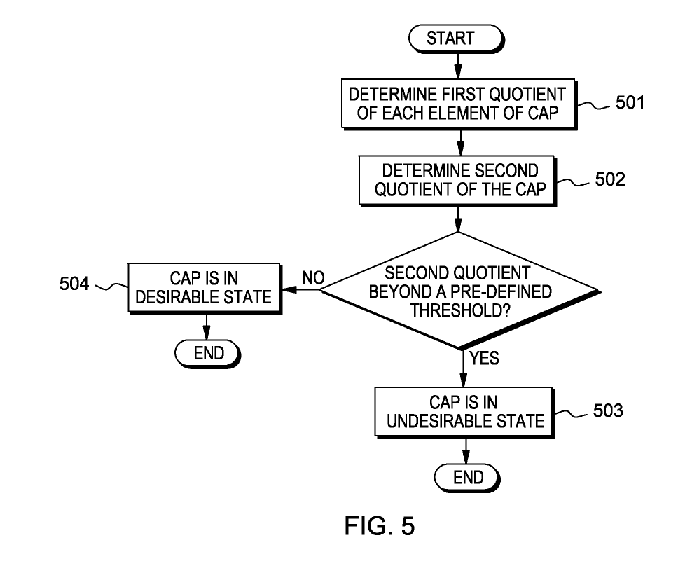

As shown in FIG. 5, according to another method of detecting an undesirable state in the captured architectural pattern in accordance with another embodiment, at step 501, a first quotient of each element of the captured architectural pattern is determined. The first quotient may be determined by analyzing the monitoring report of the element. For example, state of all or pre-determined operating parameters of the element in the monitoring report may be compared to a reference parameter and depending on the deviation of the state of the operating parameter in the monitoring report from the reference parameter, a pre-defined score may be assigned against each operating parameter. To determine the first quotient, the score of each operating parameter of the element in the monitoring report may be simply be summed up or aggregated or applied some pre-determined mathematical formula. At step 502, a second quotient of the captured architectural pattern is determined. According to an embodiment, the second quotient may be determined based on the first quotients of each element of the captured architectural pattern, for example, by summing up or aggregating the first quotients or applying some pre-determined mathematical formula. At step 503, if the determined second quotient is beyond a predefined threshold, the captured architectural pattern may be classified as being in an undesirable state. At step 504, the captured architectural pattern is classified as being in a desirable state.

The aforementioned methods of detecting the undesirable state of the captured architectural pattern is not to be construed limiting and there may be possible other methods of detecting the undesirable state of the captured architectural pattern.

The identification of the one or more architectural patterns identical to the captured architectural pattern may be performed by means of software applications such as Tivoli, TIVOLI is a registered trademark of International Business Machines Corporation, or the like configured to identify an architectural pattern from one or more other computing environments Identifying an architectural pattern identical to the captured architectural pattern is intended to mean that the other computing environments are searched for architectural patterns which have the same elements that are in the captured architectural pattern.

According to a another embodiment, after capturing the architectural pattern of the first computing environment, an architectural pattern identical or substantially identical to the captured architectural pattern in the other computing environments are identified without waiting for an undesirable state to be detected in the captured architectural pattern. The identified identical architectural patterns are stored in a database according to an embodiment. Later, as soon as the captured architectural pattern is detected to be in an undesirable state, the identified architectural patterns are forecasted to be in undesirable state and accordingly the system administrators of the computing environments to which the identified architectural patterns belong are notified of the same to enable them to take preventive actions.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method of forecasting in computing environments, the method comprising the steps of:
capturing an architectural pattern in a first computing environment;
monitoring the captured architectural pattern;
detecting a state in the captured architectural pattern;
identifying an architectural pattern identical to the captured architectural pattern in one or more other computing environments; and
forecasting the detected state in the one or more other computing environments.

2. The method of claim 1, wherein the captured architectural pattern includes one or more elements selected from the group consisting of an Operating System, Server system, Storage System, Database System, Middleware System, Network Systems and various Applications.

3. The method of claim 2, wherein the monitoring step includes monitoring the one or more elements of the captured architectural pattern.

4. The method claim 3, wherein the detection step includes detecting an error state in the one or more elements of the captured architectural pattern wherein if the error state exceeds a pre-defined threshold, the architectural pattern of which the one or more elements is a member is classified as being an undesirable state.

5. The method of claim 3, wherein the detection step includes determining a first quotient of each element of the captured architectural pattern;
determining a second quotient of the captured architectural pattern; and
classifying the captured architectural pattern as a desirable or undesirable state based on the determined second quotient.

6. The method of claim 1, wherein the first computing environment and the one or more other computing environments are enterprise computing environments.

7. The method of claim 1, wherein no single computing environment has two or more identical architectural patterns.

8. A system implemented in a hardware for forecasting in computing environments, the system comprising a computer infrastructure operable to:
capture an architectural pattern in a first computing environment;
monitor the captured architectural pattern;
detect a state in the captured architectural pattern;
identify an architectural pattern identical to the captured architectural pattern in one or more other computing environments; and
forecast the detected state in the one or more other computing environments.

9. The system of claim 8, wherein the wherein the captured architectural pattern includes one or more elements selected from the group consisting of an Operating System, Server system, Storage System, Database System, Middleware System, Network Systems and various Applications.

10. The system of claim 9, wherein the computer infrastructure is operable to monitor the one or more elements of the captured architectural pattern.

11. The system of claim 10, wherein the computer infrastructure operable to detect the state in the captured architectural pattern is further operable to detect an error state in the one or more elements of the captured architectural pattern wherein if the error state exceeds a pre-defined threshold, classify the architectural pattern of which the one or more elements is a member as being an undesirable state.

12. The system of claim 10, wherein the computer infrastructure operable to detect the state in the captured architectural pattern is further operable to
determine a first quotient of each element of the captured architectural pattern;
determine a second quotient of the captured architectural pattern; and
classify the captured architectural pattern as a desirable or undesirable state based on the determined second quotient.

13. The system of claim 8, wherein the first computing environment and the one or more other computing environments are enterprise computing environments.

14. The system of claim 8, wherein no single computing environment has two or more identical architectural patterns.

15. A computer program product comprising a computer usable storage medium having readable program code embodied in the storage medium, the computer program product comprises at least one component operable to:
capture an architectural pattern in a first computing environment;
monitor the captured architectural pattern;
detect a state in the captured architectural pattern;
identify an architectural pattern identical to the captured architectural pattern in one or more other computing environments; and
forecast the detected state in the one or more other computing environments.

16. The computer program product of claim 15, wherein the captured architectural pattern includes one or more elements selected from the group consisting of an Operating System, Server system, Storage System, Database System, Middleware System, Network Systems and various Applications.

17. The computer program product of claim 16, wherein at least one component of the computer program product is operable is operable to monitor the one or more elements of the captured architectural pattern.

18. The computer program product of claim 17, wherein at least one component of the computer program product operable to detect the state in the captured architectural pattern is further operable to detect an error state in the one or more elements of the captured architectural pattern wherein if the error state exceeds a pre-defined threshold, classify the architectural pattern of which the one or more elements is a member as being an undesirable state.

19. The computer program products of claim 17, wherein at least one component of the computer program product operable to detect the state in the captured architectural pattern is further operable to
determine a first quotient of each element of the captured architectural pattern;
determine a second quotient of the captured architectural pattern; and
classify the captured architectural pattern as a desirable or undesirable state based on the determined second quotient.

20. The computer program products of claim 15, wherein the first computing environment and the one or more other computing environments are enterprise computing environments.

21. The computer program products of claim 15, wherein no single computing environment has two or more identical architectural patterns.
